(19) United States
(12) Patent Application Publication
(10) Pub. No.: US 2025/0137885 A1
(43) Pub. Date: May 1, 2025

(54) WEAR INFORMING SYSTEM AND RELATED METHODS OF USE

(71) Applicant: Caterpillar Inc., Peoria, IL (US)

(72) Inventors: Wenming Zhao, Dunlap, IL (US); Xuefei HU, Dunlap, IL (US); Cheng Yu, Edwards, IL (US); Zhiyong Hu, Chicago, IL (US); Daojie Zhang, Northbrook, IL (US)

(73) Assignee: Caterpillar Inc., Peoria, IL (US)

(21) Appl. No.: 18/499,921

(22) Filed: Nov. 1, 2023

(51) Int. Cl. G01M 17/03

(52) U.S. Cl. CPC G01M 17/03

(57) ABSTRACT

In one instance, disclosed herein is a computer-implemented method for monitoring an undercarriage of a track-type machine, the computer-implemented method comprising: accessing a reduced order model (ROM) corresponding to the track-type machine; receiving an estimated wear level of at least one undercarriage component of a track-type machine and machine signal data generated by the track-type machine; generating an updated estimated wear level of the at least one undercarriage component using the estimated wear level, the machine signal data, and the ROM; and comparing the updated estimated wear level of the at least one undercarriage component to a wear level threshold.

### TECHNICAL FIELD

The present disclosure relates generally to monitoring the wear of one or more components of an undercarriage of a track-type machine and, more particularly, to estimating the wear of one or more components of an undercarriage using a reduced order model (ROM).

### BACKGROUND

Components (e.g., track links, bushings, pins, etc.) of an undercarriage of a machine (e.g., a track-type machine, such as a dozer or an excavator) generally wear down due to use over a period of time. Traditionally, the wear level of a component of an undercarriage of a machine can be detected and gauged by manually obtaining measurements of the component. The manually obtained measurements may then be compared to originally specified dimensions of the component. However, to obtain such measurements, the machine is typically required to suspend or forgo performing a task at a worksite. Manually obtaining measurements can negatively affect productivity at the worksite. For example, delays due to taking the machine out of service, as well as the time and effort needed to obtain the measurements, let alone transporting the machine to a site where it can be measured, or other associated tasks, may significantly reduce the operating efficiency of the machine.

Additionally, manually obtained measurements can be inaccurate (e.g., due to human error). Inaccurate measurements of the dimensions of a component, in turn, may result in incorrect predictions regarding a remaining useful life (RUL) of the component. As a result of such incorrect predictions, the components may either fail prematurely or be repaired or replaced prematurely (e.g., because the components may not be sufficiently worn to require replacement or repair). Such premature failure, or premature replacement or repair, of the component may also negatively affect productivity at a worksite. Accordingly, conventional techniques for detecting and gauging the wear level of a component of an undercarriage needs to be improved to prevent or reduce downtime at worksites (e.g., downtime associated with manually obtaining measurements of undercarriage component dimensions, downtime associated with the premature failure of undercarriage components, downtime associated with the premature repair or replacement of undercarriage components, or the like).

U.S. Pat. No. 11,704,942 discloses a system for predicting an amount of wear of one or more components of an undercarriage using a machine learning model. The machine learning model is trained, using training data, to predict the wear rate of the one or more components. The training data includes two or more of: historical sensor data, historical inspection data, or simulation data, of a simulation model. However, the system of the '942 patent requires obtaining historical data and using the historical data to train a machine learning model. Such historical data may not always be available, or may be difficult or costly to obtain. Further, training a machine learning model may be computationally intensive. Additionally, once a machine-learning model has been trained, it may be difficult or impossible to ascertain the reasoning behind decisions, predictions, or recommendations generated by such a model. The iterative wear informing system of the present disclosure solves one or more problems set forth above and/or other problems in the art.

### SUMMARY

In one aspect, a system for monitoring an undercarriage of a track-type machine comprises at least one computer-readable memory and at least one processor communicatively coupled to the at least one computer-readable memory and operative to: access a reduced order model (ROM) corresponding to the track-type machine; recursively receive updated machine signal data generated by the track-type machine; in response to receiving the updated machine signal data generated by the track-type machine, recursively generate an updated estimated wear level of at least one undercarriage component of the track-type machine by submitting the updated machine signal data into the ROM; recursively compare the updated estimated wear level of the at least one undercarriage component to a wear level threshold; and in response to determining that the updated estimated wear level of the at least one undercarriage component exceeds the wear level threshold, cause a control interface associated with the track-type machine to deliver a warning notification.

In another aspect, a computer-implemented method for monitoring an undercarriage of a track-type machine comprises: accessing, by at least one processor, a physics-based reduced order model (ROM) corresponding to the track-type machine, wherein the physics-based ROM is configured to apply one or more physics-based equations to simulate one or more aspects of the track-type machine; receiving, by the at least one processor, an estimated wear level of at least one undercarriage component of a track-type machine; receiving, by the at least one processor, machine signal data generated by the track-type machine; receiving, by the at least one processor, environmental data associated with the track-type machine; generating, by the at least one processor, an updated estimated wear level of the at least one undercarriage component by submitting the estimated wear level of the at least one undercarriage component, the machine signal data generated by the track-type machine, and the environmental data associated with the track-type machine to the physics-based ROM; and comparing, by the at least one processor, the updated estimated wear level of the at least one undercarriage component to a wear level threshold, wherein the at least one processor is configured to, in response to determining that the updated estimated wear level of the at least one undercarriage component exceeds the wear level threshold, cause a control interface associated with the track-type machine to output a warning notification.

In another aspect, a computer-implemented method for monitoring an undercarriage of a track-type machine comprises: accessing, by at least one processor, a reduced order model (ROM) corresponding to the track-type machine; receiving, by the at least one processor, an estimated wear level of at least one undercarriage component of a track-type machine; receiving, by the at least one processor, machine signal data generated by the track-type machine; generating, by the at least one processor, an updated estimated wear level of the at least one undercarriage component by submitting the estimated wear level of the at least one undercarriage component and the machine signal data generated by the track-type machine to the ROM; and comparing, by the at least one processor, the updated estimated wear level of the at least one undercarriage component to a wear level threshold, wherein the at least one processor is configured to, in response to determining that the updated estimated wear level of the at least one undercarriage component exceeds the wear level threshold, causing a control interface associated with the track-type machine to output a warning notification.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings, of which:

FIG. 1A illustrates a schematic side view of an exemplary track-type machine, according to one or more aspects of the present disclosure;

FIG. 1B illustrates a schematic side view of an undercarriage of the track-type machine of FIG. 1A;

FIG. 2 depicts a diagram of an iterative wear informing system, according to one or more aspects of the present disclosure;

FIG. 3 depicts a diagram of a recursive process for estimating the wear level of a component of an undercarriage of a track-type machine, according to one or more aspects of the present disclosure; and

FIG. 4 depicts a flowchart of a method for estimating the wear level of a component of an undercarriage of a track-type machine, according to one or more aspects of the present disclosure.

### DETAILED DESCRIPTION

Both the foregoing general description and the following detailed description are exemplary and explanatory only and are not restrictive of the features as claimed. As used herein, the terms “comprises,” “comprising,” “having,” including,” or other variations thereof, are intended to cover a non-exclusive inclusion such that a process, method, system, article, or apparatus that comprises a list of elements does not necessarily include only those elements, but may include other elements not expressly listed or inherent to such a process, method, system, article, or apparatus. Further, relative terms, such as, for example, “about,” “substantially,” “generally,” and “approximately” are used to indicate a possible variation of ±10% in a stated value. While various features and functions of the present disclosure are described herein in the context of track-type machines, it will be understood that various features and functions of the present disclosure may be applied in the context of many different types of machines. The term “machine” may refer to any machine that performs an operation associated with an industry, such as, for example, mining, construction, farming, transportation, or another industry. Moreover, one or more implements may be connected to the machine.

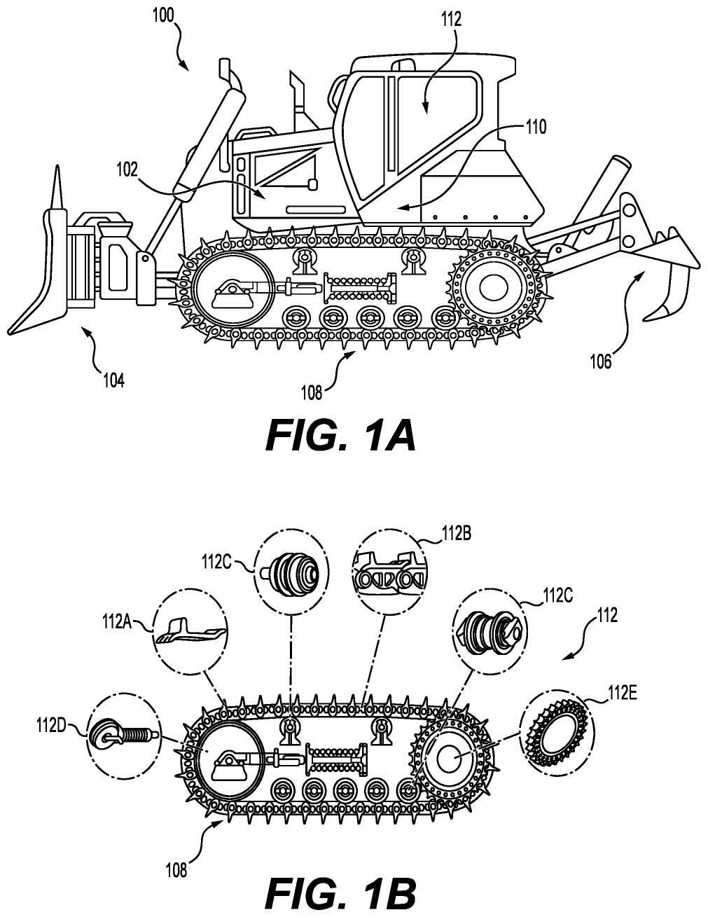

FIG. 1A illustrates a schematic side view of an exemplary embodiment of a track-type machine. In some instances, as illustrated in FIG. 1A, a machine (e.g., a track-type machine) includes an engine 102 (e.g., an internal combustion engine), a front attachment 104, a rear attachment 106, ground-engaging members 108, a controller 110, and an operator cabin 111. The operator cabin 111 may include a control interface (not shown), operatively coupled to the controller 110, with which an operator of the machine 100 (e.g., a human operator) may access the controller 110 and thereby control the machine 100. The control interface may include buttons, levers, computer interfaces, or any other type of interface for accessing a controller 110 and thereby controlling the machine 100. It will be understood that the machine 100 may additionally or alternatively be operated remotely (e.g., by an off-board operator) or automatically (e.g., without any operator involvement). The controller 110 (e.g., an electronic control module (ECM)) may control or monitor operations of the machine 100 (e.g., based on, or in response to, signals received from a control interface).

For example, the controller 110 may be operatively coupled to the engine 102, the front attachment 104, the rear attachment 106, and/or the ground-engaging members 108, such that the controller 110 may direct the machine 100 to perform a task (e.g., a task at a worksite) by engaging and coordinating the functions of engine 102, the front attachment 104, the rear attachment 106, or the ground-engaging members 108. The engine 102 (e.g., when engaged by the controller 110) may provide power to one or more components of the machine 100 (e.g., the controller 110, the front attachment 104, the rear attachment 106, or the ground-engaging members 108). Similarly, the engine 102 (e.g., when engaged by the controller 110) may provide power to one or more implements of the machine 100, such as an implement used in mining, construction, farming, transportation, or any other industry. For example, the engine 102 may power components (e.g., one or more hydraulic pumps, one or more actuators, one or more electric motors, etc.) of the front attachment 104 or the rear attachment 106 to facilitate the performance of a task by the machine 100 at a worksite.

FIG. 1B illustrates a schematic side view of an undercarriage of the track-type machine 100 of FIG. 1A. As illustrated in FIG. 1B, ground-engaging members 108 may include, or may be a component of, an undercarriage 112. In general, an undercarriage of a machine (e.g., a track-type machine) refers to the set of components that function cooperatively to support and propel the machine, including the tracks or wheels and any associated parts. The tracks of an undercarriage may include (but are not limited to) components such as track shoes 112A (e.g., plates that make direct contact with the ground), track chains 112B (e.g., interconnected links that hold the track shoes in place), rollers 112C (e.g., cylindrical wheels that support the weight of the machine and guide the tracks as they move), idlers 112D (e.g., stationary wheels that guide the track chains and help maintain tension in the undercarriage), or sprockets 112E (e.g., gears that engage with the track chains and propel the tracks by rotating them). Various components of an undercarriage may be coupled together using bushings or pins.

As mentioned above, a component of an undercarriage 112 of a machine 100 may wear down over time as the machine 100 is operated (e.g., as the machine 100 is used to perform a task at a worksite). For example, the form of the component may become warped or degraded. The wearing down of one or more components of an undercarriage 112 of a machine 100 may negatively affect the performance of the machine 100. Furthermore, the failure of one or more components of an undercarriage 112 can result in costly repairs. Thus, both monitoring the wear level of a component of an undercarriage 112 (e.g., how warped or degraded the form of the component has become, when compared to the originally specified dimensions of the component) and preventing the failure of the component may be beneficial for efficient operation of the machine 100.

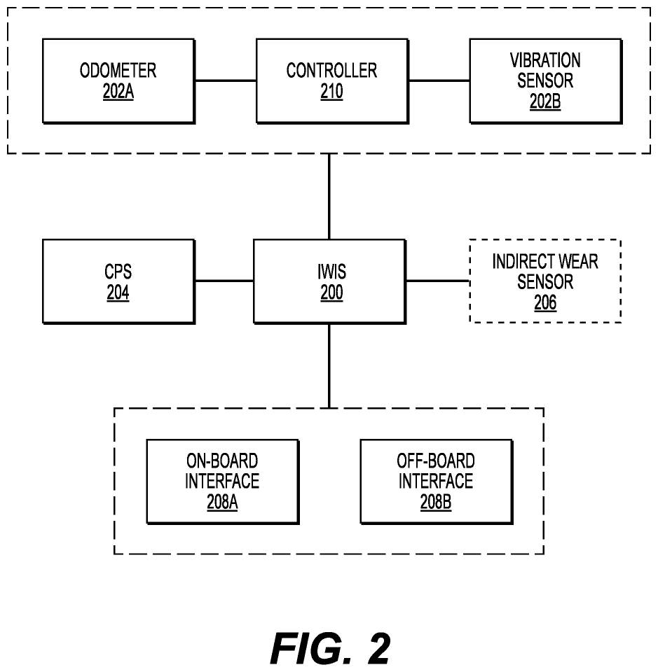

FIG. 2 depicts a diagram of an exemplary embodiment of an iterative wear informing system. In general, an Iterative Wear Informing System (IWIS) 200 encompasses a software system configured to estimate a wear level of one or more component of an undercarriage of a machine (e.g., a track-type machine). The IWIS 200 may be executed on a computing system on-board a machine (e.g., a controller, as described above) or on a computing system off-board and communicatively coupled to a machine. In some instances, an IWIS 200 estimates a wear level of a component of an undercarriage (also referred to herein as an “undercarriage component”) of a machine by receiving data generated by the machine (e.g., machine speed, machine weight, machine load, etc.; also referred to herein as “machine signal data”) or environmental data associated with the machine (e.g., weather or precipitation information) and submitting the machine signal data and/or environmental data to a reduced order model (ROM), as described below. After estimating a wear level of an undercarriage component, the IWIS 200 can compare the estimated wear level to a wear level threshold, as described below. If the estimated wear level exceeds the wear level threshold, the IWIS 200 can generate a warning notification and deliver the warning notification to a control interface associated with the machine, as described below.

For example, as depicted in FIG. 2, an IWIS 200 may be communicatively coupled to one or more direct sources of machine signal data, such as an odometer 202A, a vibration sensor 202B, or to a controller 210 that is communicatively coupled to one or more direct sources of machine signal data. For example, sources of machine signal data may include (but are not limited to) a motion sensor (e.g., odometer 202A), a load sensor, a vibration sensor (e.g., vibration sensor 202B), a pressure sensor, or a flow sensor. A motion sensor may include one or more devices capable of sensing the speed, acceleration, rotation, etc. associated with a machine and generate corresponding data. For example, a motion sensor may include an accelerometer, a tachometer, a speedometer, or an inertial measurement unit (IMU). In some instances, a motion sensor may sense or determine a distance traveled by the machine (e.g., while performing a task at a worksite). A load sensor may include one or more devices capable of sensing a load of the machine (e.g., a load of an engine of the machine) and generate load data. A vibration sensor may include one or more devices capable of sensing a vibration of or from the machine and generate vibration data. For example, a vibration sensor may include one or more IMUs. A pressure sensor may include one or more devices capable of sensing a pressure applied to a fluid of a hydraulic system that facilitates control or a front or rear attachment (as described above). A flow sensor may include one or more devices capable of sensing a flow rate of a fluid used in a hydraulic system and generate flow data. A strain sensor may be operable to sense internal forces acting on a component.

Machine signal data may include (but is not limited to) drawbar force, machine speed, machine slope, machine weight, gear setup, or track tension/sag. Similarly, as depicted in FIG. 2, an IWIS 200 may be communicatively coupled to one or more direct or indirect sources of environmental data. For example, in some instances, the IWIS 200 is communicatively coupled to an on-board temperature sensor (e.g., a thermometer) and receives weather information (e.g., temperature readings) directly from the on-board temperature sensor. Or, for example, in some instances, the IWIS 200 receives location data associated with a machine from a GPS module 204 (e.g., a GPS module 204 built into the machine) and uses the location data to indirectly obtain weather information (e.g., temperature readings or precipitation information) associated with the machine, such as from a weather database. Environmental data may also include information about a worksite where the machine is operated. For example, environmental data may also include soil information or ground roughness.

In some instances, as depicted in FIG. 2, the IWIS 200 is communicatively coupled to one or more sensors that senses a quantity or quality that indirectly corresponds to or is indicative of wear on a component. Such an indirect wear sensor 206 may include, for example, a sensor built into a machine that produces sensor data that can be used to approximate a wear level of an undercarriage component (e.g., a sound sensor that senses sound or noise emanating from the machine). Although vibration is discussed as an example of a quantity or quality that indirectly corresponds to or is indicative of wear on a component, it should be understood that any suitable quantity or quality that may be correlated with wear of a component may be used. In an example, one or more of the sources of machine data discussed above may operate as an indirect wear sensor, in various embodiments.

In some instances, data obtained or received from an indirect wear sensor 206 can be used by the IWIS 200 to optimize an estimated wear level, as described below. In some instances, as depicted in FIG. 2, the IWIS 200 is communicatively coupled to a control interface associated with a machine (e.g., an on-board interface 208A or an off-board interface 208B, as described above), and, after generating a warning notification (e.g., in response to generating an estimated wear level and determining that the estimated wear level exceeds a wear level threshold, as described below), the IWIS 200 can deliver the warning notification to the control interface.

### INDUSTRIAL APPLICABILITY

Techniques for monitoring wear of one or more undercarriage components of a machine according to one or more aspects of this disclosure, e.g., techniques that utilize a ROM and/or that operate recursively, may be used in conjunction with various types of machines that include undercarriage components that may be subject to wear, and in particular to track-type machines such as a bulldozer, an excavator, or the like. However, aspects of this disclosure may be adapted to any suitable type of machine, such as fixed machines that include one or more parts subject to wear.

In an example, a track-type machine may include or be in communication with a monitoring system. Such a machine may be operating on a job-site, and may be operated for various tasks such as hauling, excavation, earth-moving, construction, or any other suitable task. The monitoring system may be at least partially onboard the machine, and/or may be at least partially operated remotely, e.g., in a cloud environment, via a remote server, via a user device such as a computer, tablet, mobile phone, etc. The monitoring system, via one or more sensors, may collect data associated with operation of the machine and/or the machine's environment. Such data may be used by a ROM to estimate wear of one or more components of the machine. In an example, the monitoring of wear may be iterative, e.g., use incoming data to update estimations of wear on a recursive basis, each updated estimation informed by the previous. In an example, sensor data correlated to or indicative of wear may be used as an additional input to adjust or optimize the estimation of the ROM, e.g., via an adaptive fusion technique as discussed below.

Incorporation of a technique according to one or more aspects of this disclosure, such as in one or more of the examples above, may improve the operating efficiency of a machine and/or of a job-site utilizing such a machine. In an example, a machine that is monitored according to one or more aspects of this disclosure may experience less downtime. Less failures of components may occur (failure of a component is predicted in advance so that the component may be preemptively replaced). More efficient maintenance may be achieved, e.g., by replacing or repairing components as needed based on monitoring. Less manual measurement or observation of components may be performed, as monitoring may be instead performed via systems and methods according to this disclosure. Fewer components of a machine may need to be directly sensed, measured, or observed. In a particular example, relative to conventional practices in which each wear-sensitive component of a machine may need to be separately sensed and/or measured, a monitoring system according to one or more aspects of this disclosure may estimate wear of some or all components of a machine without a direct measurement or observation thereof.

In one aspect, a technique according to one or more aspects of the present disclosure may reduce computation, complexity, and/or cost relative to conventional solutions. For example, training a machine learning model requires access to training data sufficient to train the model. Such training data, e.g., real historical measurements of wear of various components over time and under various operating and/or environmental conditions, may be difficult or impractical to obtain. Further, a model may only be as accurate as the data used to train it. In other words, since manual measurement of wear is subject to human error and other error factors, training data assembled from such data would carry forward that data. Conversely, the monitoring according to one or more aspects of this disclosure may operate recursively and/or use indirect measures of wear to improve tracking of actual machine conditions and operation.

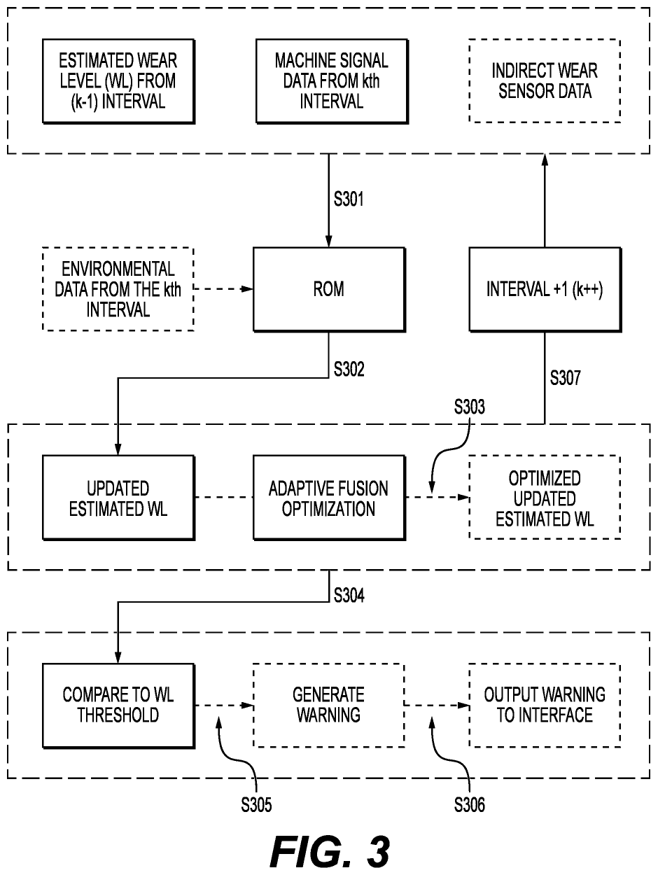

FIG. 3 depicts a diagram of an exemplary embodiment of a recursive process for estimating the wear level of an undercarriage component of a track-type machine. As mentioned above, disclosed herein is an iterative wear informing system (IWIS) capable of estimating a wear level of a component of an undercarriage of a machine (e.g., a track-type machine). As mentioned above, in some instances, an IWIS estimates a wear level of an undercarriage component using a reduced order model (ROM; e.g., ROM 300). A model of a complex system (e.g., large-scale or high-fidelity non-linear systems) can take hours or even days to simulate. A reduced order model (ROM) is a relatively simplified mathematical model of a complex system that reduces the computational complexity, or the computational storage requirement(s), of simulating one or more aspects of the complex reference system, while preserving the expected fidelity of the complex reference system within a controlled error bound. Using a ROM, a simulation of a complex system can be performed in a fraction of the time that it would require otherwise. In general, there are two main classes of methodologies for constructing a ROM: 1) data-driven methods and 2) model-based methods (e.g., physics-based or mathematics-based). In general, data-driven methods use input-output data from an original complex system to generate a ROM that accurately represents the complex reference system (e.g., within a controlled error bound). Data-driven ROMs can be generated using deep learning or machine learning techniques, such as neural networks. Model-based methods rely on a sufficient mathematical or physical understanding of an original complex system to generate a ROM (e.g., mathematical or physical equations are used to generate the ROM). Although a model-based ROM (e.g., a math-based ROM or a physics-based ROM) requires a sufficient mathematical or physical understanding of the reference system, a model-based ROM does not require a) reference data from the reference system (which is not always available) or b) a vast amount of reference data from the reference system (which is even less often available) to generate the ROM. Once a ROM simulating a complex system has been generated, the ROM can be used to estimate or predict a result of the complex reference system given a particular set of inputs. In some instances, a model-based ROM (or the result(s) of a model-based ROM) may be augmented or optimized with data-driven methods once reference data becomes available (a process referred to as “adaptive fusion”). In such an instance, the ROM may be considered both a model-based ROM and a data-driven ROM.

In the following methods, various operations are described which may be implemented by a combination of hardware and software, e.g., computer-implemented operations. While various operations are disclosed as occurring in order, it should be understood that, in various embodiments, one or more steps may be added, re-arranged, or omitted in any suitable fashion. As depicted in FIG. 3, in some instances, a recursive process for estimating the wear level of an undercarriage component of a track-type machine begins at step S301, wherein an iterative wear informing system (IWIS), executed by one or more processors (e.g., one or more processors included in a controller of the track-type machine), submits at least an estimated wear level of the undercarriage component from an immediately preceding interval of time (e.g., the k−1 interval; in some instances, the estimated wear level may be an initial wear level of zero percent for a first iteration of the recursive process, and/or a wear level corresponding to a direct measurement or observation) and machine signal data (as described above) generated during a current interval (e.g., the kth interval) into a ROM generated for the track-type machine (e.g., a ROM generated to simulate the track-type machine). In some instances, the IWIS additionally or alternatively submits environmental data generated during the current interval (e.g., the kth interval) into the ROM along with the estimated wear level of the undercarriage component.

As depicted in FIG. 3, in some instances, after submitting the estimated wear level of the undercarriage component and the machine signal data (and/or the environmental data) into the ROM, the process continues with step S302, wherein the IWIS uses the ROM to generate an updated estimated wear level of the undercarriage component for the current interval. In some instances, as depicted in FIG. 3, after generating an updated estimated wear level of the undercarriage component for the current interval, the process continues with step S303, wherein the IWIS uses reference data (e.g., indirect sensor data, as described above), if available, to optimize the updated estimated wear level of the undercarriage component using an adaptive fusion process (as described below). As depicted in FIG. 3, in some instances, after generating an updated estimated wear level of the undercarriage component (and, if applicable, after optimizing the updated estimated wear level of the undercarriage component using an adaptive fusion process), the process continues with step S304, wherein the IWIS compares the updated estimated wear level of the undercarriage component to a wear level threshold. As depicted in FIG. 3, in some instances, if the updated estimated wear level of the undercarriage component exceeds the wear level threshold, the process continues with steps S305 and S306, wherein the IWIS generates a warning notification and delivers the warning notification to a control interface, respectively. As depicted in FIG. 3, in some instances, whether or not the updated estimated wear level of the undercarriage component exceeds the wear level threshold, the process continues with step S307, wherein the interval of time is increased by one (e.g., k++), and another iteration of the process begins again at step S301.

For example, an operator of a bulldozer (e.g., a track-type machine) would like to monitor the wear level of the components of the undercarriage of the bulldozer. To do so, the operator of the bulldozer installs the iterative wear informing system (IWIS) on the controller of the bulldozer. Then, on a regular interval of time (e.g., once per week, and at the same time each week), and for each component of the undercarriage of the bulldozer, the IWIS generates an updated estimated wear level and compares the updated estimated wear level to a wear level threshold. For example, in this example, on a regular interval time, for any particular undercarriage component of the bulldozer, the IWIS submits a most recently generated estimated wear level (i.e., estimated wear level for interval k−1), machine signal data generated by the bulldozer during the most recent interval of time (i.e., machine signal data representing how the bulldozer was operated during the most recent interval of time; machine signal data for interval k), and environmental data associated with the bulldozer during the most recent interval of time (environmental data for interval k; e.g., temperature and precipitation information associated with the location(s) of the bulldozer during the most recent interval of time) into a ROM generated to simulate the bulldozer (e.g., the ROM may be a physics-based ROM generated using Reye-Archard-Khrushchov wear law and multibody dynamics to simulate the structure and operations of the bulldozer). The ROM then uses the most recently generated estimated wear level, the machine signal data, and the environmental data to generate an updated estimated wear level of the undercarriage component (i.e., an estimated wear level for interval k). The IWIS then compares the updated estimated wear level to a wear level threshold. If the updated estimated wear level exceeds the wear level threshold, the IWIS then generates a warning notification and delivers the warning notification to a control interface associated with the bulldozer (e.g., a control interface on-board the bulldozer). In some instances, whether or not the updated estimated wear level exceeds the wear level threshold, after a subsequent interval of time (i.e., interval k+1), the IWIS submits the most recently generated estimated wear level (i.e., the estimated wear level for interval k), machine signal data for interval k+1, and environmental data for interval k+1 to the ROM, and the ROM in turn generates another updated estimated wear level (i.e., an estimated wear level for interval k+1). This process continues recursively, thereby regularly monitoring the wear level of the undercarriage component. In some instances, the IWIS can perform this recursive process for each and every component of an undercarriage (e.g., each and every component of the undercarriage of the bulldozer) simultaneously.

An estimated wear level of an undercarriage component may be generated or expressed in different ways. For example, in some instances, an estimated wear level of an undercarriage component may be generated or expressed in terms of how distorted the shape of the undercarriage component has become when compared to the originally specified shape of the undercarriage component. Or, for example, in some instances, an estimated wear level of an undercarriage component may be generated or expressed in terms of how much volume the undercarriage component has lost when compared to the originally specified volume of the undercarriage component (e.g., percent volume lost). However, an estimated wear level of an undercarriage component may be generated or expressed in any other way. Such various measures may be used, for example, to determine how a component may need to be repaired and/or possible motivations for updates to the design of a component. In another example, in some instances, a particular deformation in shape and/or loss of volume of a particular portion of a component may have more of an impact than others, which may be used to inform or adjust a wear level of the component. For example a component may be worn away at different locations at different rates, and a more severe wear of the component may be used to establish the overall level of wear of the component. In some embodiments, recursively tracking wear of a component, such as via the one or more measurement types above, may include maintaining, for each such component, a model or representation of the component that is subjected to material loss and/or deformation, updated for each iteration of the ROM.

As mentioned above, in some instances, after the IWIS has generated an updated estimated wear level of an undercarriage component, the IWIS compares the updated estimated wear level to a wear level threshold. In some instances, the wear level threshold is a near-failure threshold, and an updated estimated wear level exceeding the near-failure threshold is an indication that the undercarriage component will soon need to be repaired or replaced. Any suitable near-failure threshold may be used, e.g., to balance between factors such as a safety margin, frequency of replacement or repair of a component, criticality of a component to machine operation, etc. In response to determining that an updated estimated wear level of an undercarriage component exceeds the near-failure threshold, the IWIS can generate a warning notification indicating that the undercarriage component will soon need to be repaired or replaced and deliver the warning notification to a control interface associated with the undercarriage's machine. In some such instances, in addition to generating the warning notification, the IWIS can also generate an estimate (e.g., a number of days, weeks, or months) of when the undercarriage component will need to be or should be repaired or replaced and cause a control interface associated with the undercarriage's machine to output the estimate, e.g., via a visual display, textual message, warning light, electronic message, audible warning, push notification, or any other suitable technique.

In some instances, the wear level threshold is a failure threshold, and an updated estimated wear level exceeding the failure threshold is an indication that the undercarriage component needs to be replaced promptly and/or immediately. In response to determining that an updated estimated wear level of an undercarriage component exceeds the failure threshold, the IWIS can generate a warning notification indicating that the undercarriage component needs to be replaced, e.g., prior to further operation of the machine, and cause a control interface associated with the undercarriage's machine to output the warning notification. In an embodiment, the control interface may be further configured to limit and/or prevent further operation of the machine until the undercarriage component is replaced or repaired.

In some embodiments, replacing and/or repairing an undercarriage component may include obtaining and/or setting a new level of wear for the undercarriage component. For example, in some embodiments, an initial wear level of zero may be entered for a replaced or repaired part. In another example, a direct measurement of a part may be obtained as part of the repair or replacement, and such direct measurement may be used to initialize the wear level of the part with the monitoring system.

As mentioned above, in some instances, the IWIS can monitor wear levels of multiple undercarriage components of a machine simultaneously. In some such instances, a wear level threshold for one component of an undercarriage may be different from a wear level threshold for another component of the undercarriage. For example, a near-failure threshold for a sprocket of a particular undercarriage may be 70% volume lost, while a near-failure threshold for a track shoe may be 80% volume lost, because the sprockets of the undercarriage tend to fail at a faster rate than the track shoes of the undercarriage.

As mentioned above, in some instances, the IWIS uses reference data to optimize a ROM or the output of a ROM (e.g., an updated estimated wear level, as described above) through an adaptive fusion process. As mentioned above, in some instances, a ROM employed by the IWIS is a model-based ROM (e.g., a physics-based ROM) generated using one or more mathematical or physical equations to simulate the structure or operation of a machine (e.g., a track-type machine). One advantage of using a model-based approach to generate a ROM is that a model-based approach does not require reference data to generate the ROM, as opposed to a data-driven approach, which does require reference data, and, typically, a vast amount of it. However, during the operation of a machine employing the IWIS, reference data may become available. For example, in some instances, machine signal data generated by the machine and used in conjunction with a physics-based ROM by the IWIS to generate an updated estimated wear level may also be used to train and/or fine-tune the physics-based ROM to generate more accurate estimated wear levels. Or, for example, in some instances, indirect sensor data (as described above) generated by the machine may also be used to optimize estimated wear levels produced by the physics-based ROM. In this way, an IWIS employed by a machine (e.g., a model-based ROM employed by the IWIS) may become more accurate over time as the machine is operated. In some instances, an adaptive fusion process used by the IWIS to improve or optimize a ROM or the outputs of the ROM is a Bayesian fusion process.

In an example, indirect sensor data may be correlated with the wear experienced by a particular undercarriage component. For example, an amount or rate of wear on the particular component may correlated with (e.g., based on measurements, physical relationships, etc.) a total number of vibrations observed by a particular sensor. At a certain point of time, the particular sensor may have experienced X total vibrations which, based on the known correlation, would indicate a wear level Y for the particular component. However, the latest iteration of the ROM may instead estimate a wear level of Z for the particular component. The wear level Y indicated by the known correlation may be fused with the estimate Z from the ROM, e.g., via a learning factor that weighs between the wear level Y and wear level Z. Since the ROM operates iteratively, this fused wear level will be incorporated into successive wear estimations, and thus the continued understanding of the physical state of the particular component. Although one example of indirect measure is discussed above, it should be understood that any suitable indirect measure and/or any number of indirect measures may be used in various embodiments.

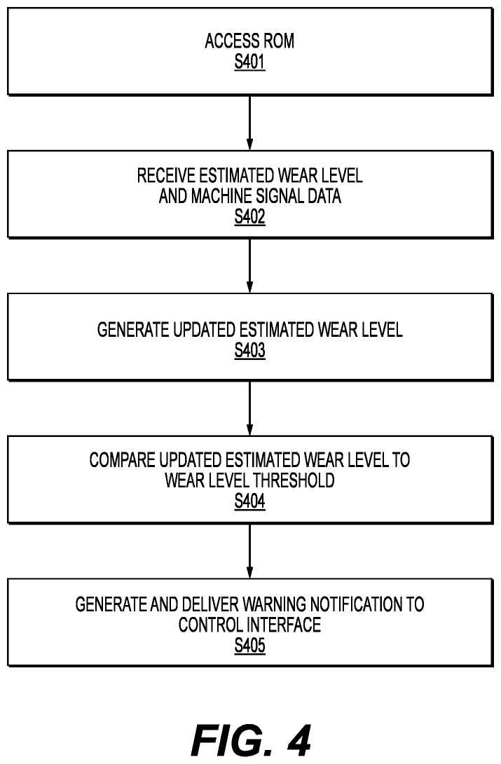

FIG. 4 depicts a flowchart of a method for estimating the wear level of a component of an undercarriage of a track-type machine. In the example depicted in FIG. 4, the method begins with step S401, wherein an iterative wear informing system (IWIS), executed by one or more processors, accesses a reduced order model (ROM) generated for a track-type machine. In some instances, the method continues with step S402, wherein the IWIS receives an estimated wear level of a component of an undercarriage of the machine and machine signal data generated by the machine. In some instances, the method continues with step S403, wherein the IWIS (e.g., the ROM accessed by the IWIS) generates an updated estimated wear level of the undercarriage component by submitting the estimated wear level of the undercarriage component and the machine signal data to the ROM accessed by the IWIS. In some instances, the method continues with step S404, wherein the IWIS compares the updated estimated wear level of the undercarriage component to a wear level threshold. In some instances, if the updated estimated wear level of the undercarriage component exceeds the wear level threshold, the method continues with step S405, wherein the IWIS generates a warning notification and delivers the warning notification to a control interface associated with the track-type machine.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

We claim:

1. A system for monitoring an undercarriage of a track-type machine, the system comprising at least one computer-readable memory and at least one processor communicatively coupled to the at least one computer-readable memory and operative to:
access a reduced order model (ROM) corresponding to the track-type machine;
recursively receive updated machine signal data generated by the track-type machine;
in response to receiving the updated machine signal data generated by the track-type machine, recursively generate an updated estimated wear level of at least one undercarriage component of the track-type machine by submitting the updated machine signal data into the ROM;
recursively compare the updated estimated wear level of the at least one undercarriage component to a wear level threshold; and
in response determining that the updated estimated wear level of the at least one undercarriage component exceeds the wear level threshold, cause a control interface associated with the track-type machine to deliver a warning notification.

2. The system of claim 1, wherein accessing the ROM corresponding to the track-type machine further comprises accessing a physics-based ROM, wherein the physics-based ROM is configured to apply one or more physics-based equations to simulate one or more aspects of the track-type machine.

3. The system of claim 1:
wherein the at least one processor is further operative to recursively receive updated environmental data associated with the track-type machine; and
wherein recursively generating the updated estimated wear level of the at least one undercarriage component further comprises submitting the updated environmental data associated with the track-type machine and the updated estimated wear level of the at least one undercarriage component to the ROM.

4. The system of claim 1, wherein:
recursively comparing the updated estimated wear level of the at least one undercarriage component to the wear level threshold further comprises comparing the updated estimated wear level to a near-failure threshold; and
the at least one processor is further operative to, in response to determining that the updated estimated wear level of the at least one undercarriage component exceeds the near-failure threshold, generate an estimate of when the undercarriage component will need to be replaced and cause the control interface to output the estimate.

5. The system of claim 1, wherein:
recursively comparing the updated estimated wear level of the at least one undercarriage component to the wear level threshold further comprises comparing the updated estimated wear level to a failure threshold; and
the at least one processor is further operative to, in response to determining that the updated estimated wear level of the at least one undercarriage component exceeds the failure threshold, cause the control interface to output an indication that the at least one undercarriage component needs to be replaced.

6. The system of claim 1, wherein the at least one processor is further operative to prompt the control interface to display the warning notification within an interface built into the track-type machine.

7. A computer-implemented method for monitoring an undercarriage of a track-type machine, the method comprising:
accessing, by at least one processor, a physics-based reduced order model (ROM) corresponding to the track-type machine, wherein the physics-based ROM is configured to apply one or more physics-based equations to simulate one or more aspects of the track-type machine;
receiving, by the at least one processor, an estimated wear level of at least one undercarriage component of a track-type machine;
receiving, by the at least one processor, machine signal data generated by the track-type machine;
receiving, by the at least one processor, environmental data associated with the track-type machine;
generating, by the at least one processor, an updated estimated wear level of the at least one undercarriage component by submitting the estimated wear level of the at least one undercarriage component, the machine signal data generated by the track-type machine, and the environmental data associated with the track-type machine to the physics-based ROM; and
comparing, by the at least one processor, the updated estimated wear level of the at least one undercarriage component to a wear level threshold, wherein the at least one processor is configured to, in response to determining that the updated estimated wear level of the at least one undercarriage component exceeds the wear level threshold, cause a control interface associated with the track-type machine to output a warning notification.

8. The computer-implemented method of claim 7, further comprising:
recursively receiving, by the at least one processor, updated machine data generated by the track-type machine;
recursively receiving, by the at least one processor, updated environmental data associated with the track-type machine;
recursively generating, by the at least one processor, the updated estimated wear level of the at least one undercarriage component; and
recursively comparing, by the at least one processor, the updated estimated wear level of the at least one undercarriage component to the wear level threshold.

9. The computer-implemented method of claim 8, wherein the updated estimated wear level is recursively generated and compared to the wear level threshold on a regular interval of time.

10. The computer-implemented method of claim 7, wherein:
comparing the updated estimated wear level of the at least one undercarriage component to the wear level threshold further comprises comparing the updated estimated wear level to a near-failure threshold; and
the at least one processor is further configured to, in response to determining that the updated estimated wear level of the at least one undercarriage component exceeds the near-failure threshold, generate an estimate of when the undercarriage component will need to be replaced and cause the control interface to output the estimate.

11. The computer-implemented method of claim 7, wherein:
comparing the updated estimated wear level of the at least one undercarriage component to the wear level threshold further comprises comparing the updated estimated wear level to a failure threshold; and
the at least one processor is further configured to, in response to determining that the updated estimated wear level of the at least one undercarriage component exceeds the failure threshold, cause the control interface to output an indication that the at least one undercarriage component needs to be replaced.

12. The computer-implemented method of claim 7, further comprising:
receiving, by the at least one processor, sensor data that is indirectly indicative of wear of the at least one undercarriage component; and
optimizing, by the at least one processor, the updated estimated wear level of the at least one undercarriage component by updating the physics-based ROM with the sensor data using an adaptive fusion method.

13. The computer-implemented method of claim 7, wherein the at least one processor is further configured to cause the control interface to display the warning notification within an interface built into the track-type machine.

14. A computer-implemented method for monitoring an undercarriage of a track-type machine, the method comprising:
accessing, by at least one processor, a reduced order model (ROM) corresponding to the track-type machine;
receiving, by the at least one processor, an estimated wear level of at least one undercarriage component of a track-type machine;
receiving, by the at least one processor, machine signal data generated by the track-type machine;
generating, by the at least one processor, an updated estimated wear level of the at least one undercarriage component by submitting the estimated wear level of the at least one undercarriage component and the machine signal data generated by the track-type machine to the ROM; and
comparing, by the at least one processor, the updated estimated wear level of the at least one undercarriage component to a wear level threshold, wherein the at least one processor is configured to, in response to determining that the updated estimated wear level of the at least one undercarriage component exceeds the wear level threshold, causing a control interface associated with the track-type machine to output a warning notification.

15. The computer-implemented method of claim 14, further comprising:
recursively receiving, by the at least one processor, updated machine data generated by the track-type machine;
recursively generating, by the at least one processor, and updated estimated wear levels of the at least one undercarriage component; and
recursively comparing, by the at least one processor, the updated estimated wear level of the at least one undercarriage component to the wear level threshold.

16. The computer-implemented method of claim 15, wherein the updated estimated wear level is recursively generated and compared to the wear level threshold on a regular interval of time.

17. The computer-implemented method of claim 14, wherein accessing the ROM corresponding to the track-type machine further comprises accessing a physics-based ROM configured to apply one or more physics-based equations to simulate one or more aspects of the track-type machine.

18. The computer-implemented method of claim 14:
further comprising receiving, by the at least one processor, environmental data associated with the track-type machine; and
wherein generating the updated estimated wear level of the at least one undercarriage component further comprises submitting the estimated wear level of the at least one undercarriage component, the machine signal data generated by the track-type machine, and the environmental data associated with the track-type machine to the ROM.

19. The computer-implemented method of claim 14, wherein:
comparing the updated estimated wear level of the at least one undercarriage component to the wear level threshold further comprises comparing the updated estimated wear level to a near-failure threshold; and
the at least one processor is further configured to, in response determining that the updated estimated wear level of the at least one undercarriage component exceeds the near-failure threshold, generate an estimate of when the at least one undercarriage component will need to be replaced and causing the control interface to output the estimate.

20. The computer-implemented method of claim 14, wherein:
comparing the updated estimated wear level of the at least one undercarriage component to the wear level threshold further comprises comparing the updated estimated wear level to a failure threshold; and
the at least one processor is further configured to, in response to determining that the updated estimated wear level of the at least one undercarriage component exceeds the failure threshold, cause the control interface to output an indication that the undercarriage component needs to be replaced.
